(19) United States
(12) Patent Application Publication
(10) Pub. No.: US 2026/0134203 A1
(43) Pub. Date: May 14, 2026

(54) PROMPT EDITING

(71) Applicant: Beijing Zitiao Network Technology Co., Ltd., Beijing (CN)

(72) Inventors: Hui YAO, Beijing (CN); Qinghong CHEN, Beijing (CN); Yiran PENG, Beijing (CN); Zhenfei HAO, Beijing (CN); Chengwu LI, Beijing (CN)

(21) Appl. No.: 19/185,337

(22) Filed: Apr. 22, 2025

(30) Foreign Application Priority Data
Nov. 11, 2024 (CN) 202411607113.8

(51) Int. Cl. G06F 40/186

(52) U.S. Cl. CPC G06F 40/186

(57) ABSTRACT

A method, apparatus, device, storage medium and program product for prompt editing are provided according to embodiments of the disclosure. At the client, an example method includes: in response to sending a task request to a server device, receiving a task execution instruction corresponding to the task request from the server device for execution; receiving prediction information for the task request from the server device, the prediction information indicating at least one predicted execution result of the task execution instruction and a predicted response corresponding to the at least one predicted execution result; and after the execution of the task execution instruction is completed, providing a response to the task request based on a match between a target execution result of the task execution instruction and the at least one predicted execution result.

### CROSS-REFERENCE TO RELATED APPLICATIONS

This application claims the benefit of CN Patent Application No. 202411607113.8 filed on Nov. 11, 2024, entitled “METHOD, APPARATUS, DEVICE, STORAGE MEDIUM AND PROGRAM PRODUCT FOR EDITING A PROMPT”, which is hereby incorporated by reference in its entirety.

### FIELD

Embodiments of the present disclosure generally relate to the field of computers, and more particularly, to prompt editing.

### BACKGROUND

With the development of information technology, various terminal devices may provide various services to people in work and life. For example, applications and digital assistants that may provide different services may be deployed in terminal devices. Digital assistants are provided to assist users in various task processing needs in different applications and scenarios. Digital assistants usually have intelligent dialogue and task processing capabilities. Generally, digital assistants may support users to input questions in natural language, and perform tasks and provide responses based on the understanding of natural language input and logical reasoning ability.

### SUMMARY

In a first aspect of the present disclosure, a method for prompt editing is provided. The method is implemented at a client device, and the method includes: in response to sending a task request to a server device, receiving a task execution instruction corresponding to the task request from the server device for execution; receiving prediction information for the task request from the server device, the prediction information indicating at least one predicted execution result of the task execution instruction and a predicted response corresponding to the at least one predicted execution result; and after the execution of the task execution instruction is completed, providing a response to the task request based on a match between a target execution result of the task execution instruction and at least one predicted execution result.

In a second aspect of the present disclosure, an apparatus for prompt editing is provided. The apparatus is implemented at a client device, and includes: a task request sending module, configured to receive a task execution instruction corresponding to the task request from the server device in response to sending a task request to the server device for execution; a prediction information receiving module, configured to receive prediction information for the task request from the server device, the prediction information indicating at least one predicted execution result of the task execution instruction and a predicted response corresponding to the at least one predicted execution result; and a response providing module, configured to provide a response to the task request based on a match between a target execution result of the task execution instruction and at least one predicted execution result after the execution of the task execution instruction is completed.

In a third aspect of the present disclosure, an electronic device is provided. The device includes at least one processing unit; and at least one memory, the at least one memory is coupled to the at least one processing unit and stores instructions for execution by the at least one processing unit. When the instructions are executed by the at least one processing unit, the electronic device executes the method of the first aspect.

In a fourth aspect of the present disclosure, a computer-readable storage medium is provided, wherein a computer program is stored on the medium, and when the computer program is executed by a processor, the method of the first aspect is implemented.

In a fifth aspect of the present disclosure, a computer program product is provided, which includes a computer program, wherein when the computer program is executed by a processor, the method according to the first aspect of the present disclosure is implemented.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a schematic diagram showing an example environment in which embodiments of the present disclosure may be implemented;

FIGS. 2A and 2B illustrate example interfaces according to some embodiments of the present disclosure;

FIGS. 3A to 3E show examples of an editing interface for creating a prompt for a prompt library according to some embodiments of the present disclosure;

FIGS. 4A and 4B illustrate examples of configuration areas for receiving a prompt according to some embodiments of the present disclosure;

FIGS. 5A to 5D illustrate examples of editing interfaces for target functions according to some embodiments of the present disclosure;

FIG. 6A shows an example of highlighting a portion of a prompt in an editing interface according to some embodiments of the present disclosure;

FIGS. 6B to 6H show example interfaces related to creation and application of a prompt in a prompt library according to other embodiments of the present disclosure;

FIGS. 7A to 7E are schematic diagrams showing example interfaces for a comment function on a prompt according to some embodiments of the present disclosure;

FIG. 8 shows a flow chart of a method for prompt editing according to some embodiments of the present disclosure;

FIG. 9 shows a schematic structural block diagram of an apparatus for editing a prompt according to some embodiments of the present disclosure; and

FIG. 10 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as being limited to the embodiments set forth herein. On the contrary, these embodiments are provided to provide a more thorough and complete understanding of the present disclosure. It should be understood that the drawings and embodiments of the present disclosure are only for exemplary purposes and are not intended to limit the scope of protection of the present disclosure.

In the description of the embodiments of the present disclosure, the term “including” and similar terms should be understood as open inclusion, that is, “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

Herein, unless explicitly stated, executing a step “in response to A” does not mean executing the step immediately after “A” but may include one or more intermediate steps.

It is understandable that the data involved in this technical solution (including but not limited to the data itself, the acquisition, use, storage or deletion of the data) shall comply with the requirements of relevant laws, regulations and relevant provisions.

It is understandable that before using the technical solutions disclosed in the various embodiments of the present disclosure, the types, usage range, usage scenarios, etc. of the information involved in the present disclosure should be informed to relevant users and their authorization should be obtained in an appropriate manner in accordance with relevant laws and regulations. The relevant users may include any type of right holders, such as individuals, enterprises, and groups.

For example, in response to receiving an active request from a user, prompt information is sent to the relevant user to clearly prompt the relevant user that the operation requested to be performed will require obtaining and using the information of the relevant user, so that the relevant user may independently choose whether to provide information to software or hardware such as an electronic device, application, server or storage medium that executes the operation of the technical solution of the present disclosure based on the prompt information.

As an optional but non-limiting implementation, in response to receiving an active request from a relevant user, prompt information is sent to the relevant user, for example, in the form of a pop-up window, in which the prompt information may be presented in text form. In addition, the pop-up window may also carry a selection control for the user to select “agree” or “disagree” to provide information to the electronic device.

It is understandable that the above notification and the process of obtaining user authorization are merely illustrative and do not constitute a limitation on the implementation of the present disclosure. Other methods that meet relevant laws and regulations may also be applied to the implementation of the present disclosure.

As used herein, the term “model” may learn the association between the corresponding input and output from the training data, so that after the training is completed, the corresponding output may be generated for a given input. The generation of the model may be based on machine learning technology. Deep learning is a machine learning algorithm that processes inputs and provides corresponding outputs by using multi-layer processing units. A neural network model is an example of a model based on deep learning. In this article, “model” may also be referred to as “machine learning model”, “learning model”, “machine learning network” or “learning network”, and these terms are used interchangeably in this article.

Digital assistants may be used as tools for people to work, study and live effectively. Generally, the development of digital assistants is similar to the development of general applications. Developers with programming skills are required to define the various capabilities of digital assistants by writing complex codes and deploying digital assistants on appropriate operating platforms so that users can download, install and use digital assistants.

With the diversification of application scenarios and the increasing availability of machine learning technology, it is expected that more digital assistants with different capabilities will be developed to support task processing in various segments or to meet the personalized needs of different users. Users may create different prompts and provide the prompts to the machine learning model to use the machine learning model to determine different digital assistants. Users may also adjust the digital assistant by adjusting the prompt input. Traditionally, if it is desired to share the prompt between multiple users, the user who created the prompt often needs to copy the created prompt and then send the copied prompt to other users. This affects the efficiency of sharing the prompt between multiple users and the efficiency of other users editing the prompt.

According to an embodiment of the present disclosure, an improved scheme for editing a prompt is provided. According to the scheme, an editing interface for editing a prompt is presented, wherein the edited prompt is input into a machine learning model for the machine learning model to determine a model output. An editing block is configured at a selected location of the editing interface in response to triggering an editing block function, wherein content may be filled in the editing block and the filled content is editable. The content filled in the editing block is determined as a part of the prompt in response to confirmation on the editing of the prompt.

Thus, an editing block may be configured in the prompt, so that the editing block may be filled with content and the filled content is editable. This may facilitate the user to fill, modify, etc. the content in the editing block, so as to obtain the desired prompt. This helps to improve the efficiency of prompt editing.

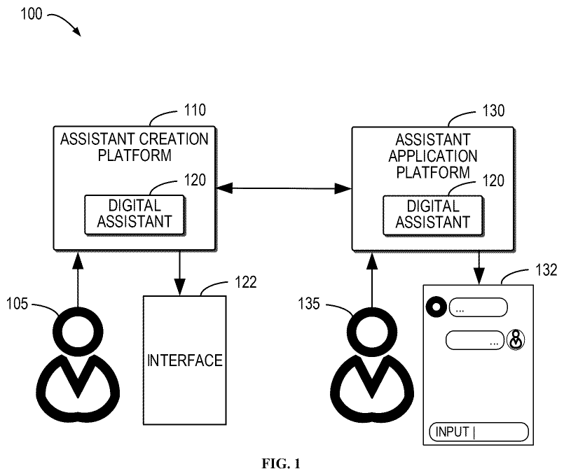

FIG. 1 shows a schematic diagram of an example environment 100 in which embodiments of the present disclosure may be implemented. Environment 100 involves an assistant creation platform 110 and an assistant application platform 130.

As shown in FIG. 1, the assistant creation platform 110 may provide a digital assistant creation and releasing environment for the user 105. In some embodiments, the assistant creation platform 110 may be a low-code platform that provides a collection of tools for digital assistant creation. The assistant creation platform 110 may support visual development of digital assistants, so that developers may skip the manual coding process and speed up the application development cycle and cost. The assistant creation platform 110 may support any appropriate platform for users to develop digital assistants and other types of applications, such as a platform based on application platform as a service (aPaaS). Such a platform may support users to efficiently develop applications and realize operations such as application creation and application function adjustment.

The assistant creation platform 110 may be deployed locally on the terminal device of the user 105, and/or may be supported by a remote server. For example, the terminal device of the user 105 may run a client of the assistant creation platform 110, which may support the interaction between the user and the assistant creation platform 110. In the case where the assistant creation platform 110 runs locally on the terminal device of the user, the user 105 may directly use the client to interact with the local assistant creation platform 110. In the case where the assistant creation platform 110 runs on a server device, the server device may, based on the communication connection with the terminal device, enable the supply of services to the client running in the terminal device. The assistant creation platform 110 may present a corresponding interface 122 to the user 105 based on the operation of the user 105, so as to output information to the user 105 and/or receive information from the user 105.

In some embodiments, the assistant creation platform 110 may be associated with a corresponding database, which stores the data or information required for the digital assistant creation process supported by the assistant creation platform 110. For example, the database may store the code and description information corresponding to each functional module that constitutes the digital assistant. The assistant creation platform 110 may also perform operations such as calling, adding, deleting, and updating the functional modules in the database. The database may also store operations that may be performed on different functional blocks. Exemplarily, in a scenario where a digital assistant is to be created, the assistant creation platform 110 may call the corresponding functional blocks from the database to build a digital assistant. These modules may include, but are not limited to, plug-ins for implementing specific functions, workflows (a workflow may be composed of a series of workflow nodes with a sequential execution order and dependencies), knowledge bases, etc.

In an embodiment of the present disclosure, a user 105 may create a digital assistant 120 as needed on an assistant creation platform 110 and release the digital assistant 120. The digital assistant 120 may be released to any appropriate assistant application platform 130, as long as the assistant application platform 130 may support the operation of the digital assistant 120. After releasing, the digital assistant 120 may be used for dialogue interaction with the user 135. The client of the assistant application platform 130 may present an interactive window 132 of the digital assistant 120, such as a conversation window, in the client interface. As an intelligent assistant, the digital assistant 120 has intelligent dialogue and information processing capabilities. The user 135 may input a session message in the conversation window, and the digital assistant 120 may determine the reply message based on the created configuration information and present it to the user in the interaction window 132. In some embodiments, depending on the configuration of the digital assistant 120, the interactive message with the digital assistant 120 may include messages in multimodal forms, such as text messages (e.g., natural language text), voice messages, image messages, video messages, and the like.

The assistant creation platform 110 and/or the assistant application platform 130 may run on appropriate electronic devices. The electronic device here may be any type of device with computing capabilities, including terminal devices or server devices. The terminal device may be any type of mobile terminal, fixed terminal or portable terminal, including mobile phones, desktop computers, laptop computers, notebook computers, netbook computers, tablet computers, media computers, multimedia tablets, personal communication systems (PCS) devices, personal navigation devices, personal digital assistants (PDAs), audio/video players, digital cameras/camcorders, positioning devices, television receivers, radio broadcast receivers, e-book devices, gaming devices, or any combination of the foregoing, including accessories and peripherals of these devices or any combination thereof. The server device may include, for example, a computing system/server, such as a mainframe, an edge computing node, a computing device in a cloud environment, and the like. In some embodiments, the assistant creation platform 110 and/or the assistant application platform 130 may be implemented based on cloud services.

It should be understood that the structure and functionality of environment 100 are described for exemplary purposes only and do not imply any limitation on the scope of the present disclosure. For example, although FIG. 1 shows a single user interacting with assistant creation platform 110 and a single user interacting with assistant application platform 130, in fact, multiple users may access assistant creation platform 110 to each create a digital assistant, and each digital assistant may be used to interact with multiple users.

the present disclosure will be described in detail below with reference to the examples of the accompanying drawings. It should be understood that the pages/interfaces shown in the accompanying drawings are merely examples, and various page designs/interfaces may actually exist. The various graphical elements in the page/interface may have different arrangements and different visual representations, one or more of which may be omitted or replaced, and one or more other elements may also exist. The embodiments of the present disclosure are not limited in this respect.

The prompt editing process described in the embodiments of the present disclosure may be implemented on an assistant creation platform, a terminal device equipped with an assistant creation platform and/or a server corresponding to the assistant creation platform. In the examples below, for the purpose of discussion, it is described from the perspective of an assistant creation platform, such as the assistant creation platform 110 shown in FIG. 1. The interface presented by the assistant creation platform 110 may be presented via the terminal device of the user 105, and user input may be received via the terminal device of the user 105. In this article, the user 105 who creates a digital assistant is sometimes also referred to as an assistant creator, an assistant developer, etc.

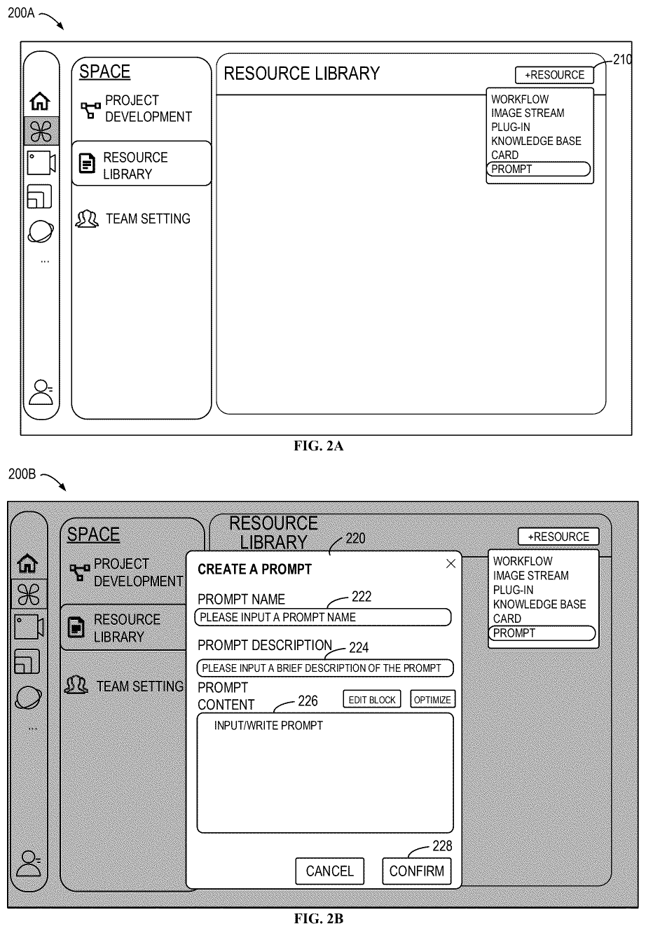

In some embodiments, the assistant creation platform 110 may also provide a resource library interface for the digital assistant. Example 200A, as shown in FIG. 2A, shows an example of a resource library interface. Example 200A includes a resource selection control 210, and the assistant creation platform 110 may present a resource list in response to receiving a trigger on the resource selection control 210. The resource list includes at least one option corresponding to at least one resource, at least one resource includes at least a prompt, and at least one option includes at least an option corresponding to the prompt. It may be understood that at least one resource may also include other resources, such as workflows, image streams, plug-ins, knowledge bases, message cards, etc. The assistant creation platform 110 may respond to receiving a selection of an option corresponding to the prompt, determine that a resource creation request for the prompt is received, and present an example 200B as shown in FIG. 2B. Example 200B includes an editing interface 220 for the prompt.

The interface 220 includes an area 222 for editing a prompt name, an area 224 for editing the description information of the prompt, and an area 226 for editing prompt content. The description information of the prompt may be used to introduce the scenarios in which the prompt may be used, for example, whether it is suitable for a character avatar digital assistant or an efficiency tool digital assistant. The description information of the prompt may also additionally or alternatively introduce the functions that the prompt may achieve. For example, the description information may indicate that the machine learning model may call certain plug-ins, workflows, databases, knowledge bases, etc. based on the prompt. But this is only exemplary, and the present disclosure does not limit this. The prompt content may include the full text of the prompt. The interface 220 may also include a confirmation control 228, and the assistant creation platform 110 may edit the prompt based on the content in area 222, area 224, and area 226 in response to receiving a trigger on the confirmation control 228.

an edited prompt may include, for example, a system prompt. In some examples, for a digital assistant based on a machine learning model, in a scenario where the digital assistant interacts with user A, if an input of user A is received, the prompt to be input to the machine learning model associated with the digital assistant may be determined based on an input of user A and the system prompt. The machine learning model may determine a model output based on the input prompt, and the output will be used to determine a reply to user A.

The edited prompt will be stored in the prompt library in the resource library. This prompt library may be a personal prompt library of a user, or a prompt library of multiple users (such as a team prompt library). If the prompt library is a team prompt library, the prompt in the prompt library may be a prompt created by any user in the team, and each user in the team may use the prompt created by other users in the team and stored in the prompt library.

In some embodiments, the permission of at least one of the application, editing, or deletion of the prompt in the prompt library is based on the role of the user. It is understandable that, according to the role of the user, the prompt in the prompt library may be copied or directly used in the digital assistant or workflow node. Correspondingly, according to the role of the user, the prompt in the prompt library may also be edited, deleted, etc. operations. For example, for the creator of the prompt (for example, user 105), the prompt in the prompt library may be edited, deleted, etc. operations. For other users belonging to the same organization/team/workspace as user 105, the prompt in the prompt library may be accessed, applied, and copied. In some embodiments, which users may have the ability to access, apply, and/or copy the prompt by the creator of the prompt, or the ability to access, apply, and/or copy the user to each prompt may be configured based on the default policy. Hereinafter, how to add a prompt in the prompt library and how to apply the prompt in the prompt library are described in more detail.

It should be noted that, in addition to the above-mentioned editing interface 220, the assistant creation platform 110 may also provide other areas or interfaces that may be used to edit a prompt. For example, the assistant creation platform 110 may also provide an editing interface/editing area for a prompt in a workflow node in a workflow, a configuration area for receiving a prompt input in a natural language in a user interface for creating a digital assistant 120, and so on. The present disclosure does not limit the area or interface for editing a prompt, nor does it limit the specific way of presenting the area or interface.

The editing interface 220 here may be considered as an editing interface for creating a prompt for the prompt library, and the configuration area for receiving a prompt in the user interface for creating the digital assistant 120 and the editing interface/editing area of the prompt in the workflow node may be considered as an editing interface for the target function, and the target function may include a digital assistant or a workflow node, and the target function executes based on a machine learning model (such as a target machine learning model). The editing interface for the target function may include, for example, a user interface for creating the digital assistant 120.

In creating a digital assistant, reply of the digital assistant to the user is generated based on the machine learning model specified by the creator. In the editing of the workflow, one or more workflow nodes may be selected as workflow nodes based on a machine learning model, which is configured to use a machine learning model to process the input of the workflow node to obtain the output of the workflow node. It should be understood that in addition to digital assistants or workflow nodes, there may also be other types of functions based on machine learning models. For those functions, the embodiments of the present disclosure are equally applicable. According to some embodiments of the present disclosure, the assistant creation platform 110 may confirm the content filled in the editing block as a part of the prompt for the machine learning model in response to confirmation on creation of the target function.

In some embodiments, the prompt may include a set character, that is, a description of the role or responsibilities played by the digital assistant, the reply style, etc., thereby guiding the machine learning model to process the input according to the set character. The prompt may also include functions and workflows, such as describing the functions and workflows of the digital assistant, and stipulating how the digital assistant answers user questions in different scenarios. Thereby guiding the machine learning model to process the input according to the functions and workflows. The prompt may also include constraints and restrictions, that is, limiting the reply range of the digital assistant, such as constraining what the digital assistant should answer and what it should not answer. Additionally, the prompt may also include specifying the reply format of digital assistant so that the digital assistant answers the input of the user according to the reply format.

In some embodiments, the prompt may indicate the definition of the reply style of the digital assistant to be created. By setting the reply style, the replies of the created digital assistant may be differentiated and may show a specific personality to the user. Alternatively or additionally, in some embodiments, the prompt may indicate a description of the functions supported by the digital assistant to be created. Alternatively or additionally, in some embodiments, the prompt may indicate at least one reply format of the digital assistant to be created. The reply format may include, for example, Markdown (Lightweight Markup Language) and the like.

In some embodiments, alternatively or additionally, the prompt may also indicate at least one workflow to be executed by the digital assistant 120 to be created. Each workflow may correspond to individual operations of the digital assistant 120 when performing a specific function. In other words, the user 105 may be allowed to describe how the digital assistant 120 is to perform a certain function in natural language. It is understandable that the functions based on the machine learning model (for example, the digital assistant or the workflow node in the workflow) may add the functions it possesses. For example, the digital assistant or the workflow node may have the functions of calling plug-ins, knowledge bases, databases, triggers, workflows, and the like. Accordingly, the usage scenarios and descriptions of these functions may be described in the prompt corresponding to the digital assistant or the workflow node.

It should be understood that the user may actually freely try different prompts to build a digital assistant whose reply meets the user's expectations. For example, in the prompt, the user 105 may be allowed to input the requirements for the reply language of the digital assistant 120 and the constraints on the reply content of the digital assistant 120 (for example, the number of words for different types of replies, the type of reply content, etc.).

The machine learning model may run locally on the assistant creation platform 110 or on a remote server. In some embodiments, the machine learning model may be based on a language model (LM). The language model may have question-answering capabilities by learning from a large amount of corpus. The machine learning model may also be based on other appropriate models. During the creation of the function, a specific configuration area is provided for the user to provide a prompt, and the configuration of the prompt may be completed in a natural language manner. In this way, the user may easily constrain the output of the model and configure a variety of digital assistants. In some embodiments, the machine learning model may also be based on any appropriate model structure, including but not limited to Transformer models, convolutional neural networks (CNN), recurrent neural networks (RNN), deep neural networks (DNN), and the like.

In an embodiment of the present disclosure, the assistant creation platform 110 may present an editing interface for editing a prompt. As mentioned above, the edited prompt is input into the machine learning model for the machine learning model to determine the model output, and the digital assistant will determine the reply to the user based on the model output. The assistant creation platform 110 may configure the editing block at a selected location in the editing interface in response to the trigger on the editing block function, and the content in the editing block may be filled and the filled content is editable. Specifically, the editing block may be configured in the prompt content. One or more editing blocks may be configured in the prompt as needed. The configuration of the editing block may make the prompt present a structured characteristic, so that the prompt is easier to be understood by the developer user and shared among multiple developer users. In some embodiments, only the content in the editing block in the prompt may be edited, and the content of the non-editing block part cannot be edited. In other embodiments, the content in the editing block and the content in the non-editing block in the prompt may be edited, and the editing methods of the two may be the same or different.

If the prompt contains an editing block, when the prompt is used again or edited, the user may create new prompt content in the provided editing block. In the process of editing a digital assistant or a workflow node, the user may edit the prompt content corresponding to the digital assistant or the workflow node in the editing block. In some embodiments, in a scenario where an editing block exists for a prompt resource, user 105 may edit the content contained in the prompt. Alternatively, the user may edit the content contained in the editing block in the prompt. In some examples, the content contained in the editing block may be provided to users (e.g., developers) who use the prompt resource in the form of a form to be filled out.

The assistant creation platform 110 may detect the trigger on the editing block function in any appropriate manner. In some embodiments, the assistant creation platform 110 may determine that the trigger on the editing block function is detected in response to detecting the selection of a predetermined control. The predetermined control here may be, for example, an adding control, an edit control, etc. for the editing block in the editing interface. Alternatively or additionally, in some embodiments, the assistant creation platform 110 may also determine that the trigger on the editing block function is detected in response to detecting the input of a predetermined symbol detected in the editing interface. The predetermined symbol here may be any appropriate symbol, and the present disclosure does not limit the specific symbol. Alternatively or additionally, in some embodiments, the assistant creation platform 110 may be deployed in any appropriate electronic device, and the electronic device may include a physical control. The assistant creation platform 110 may determine that the trigger on the editing block function is detected in response to receiving a trigger on an indicating physical control (such as a shortcut key). It may be understood that the assistant creation platform 110 may also detect the trigger on the editing block function in response to receiving any other method such as a right-click, a floating operation, etc., and the present disclosure does not limit the specific method.

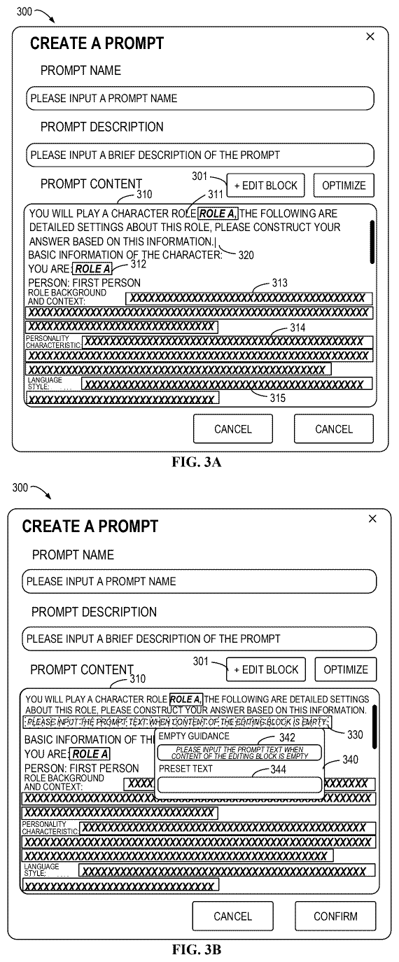

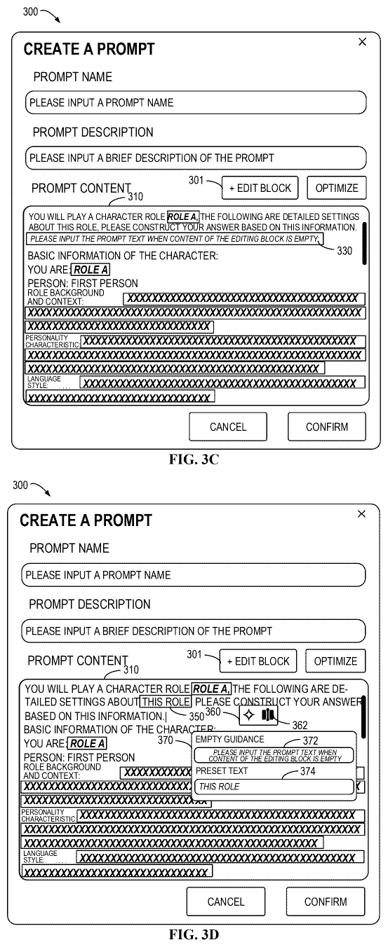

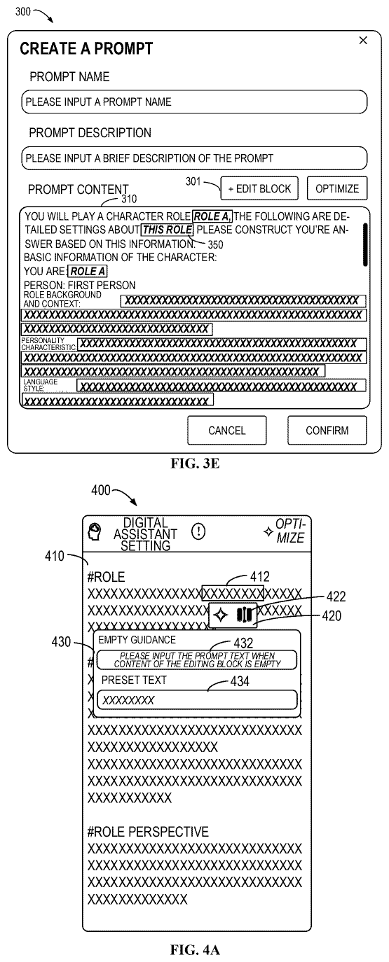

In some embodiments, in order to facilitate the user to intuitively identify the editing block, the assistant creation platform 110 may present the editing block or the content in the editing block, and the content of the non-editing block in the prompt in different visual styles. Referring to FIG. 3A, FIG. 3A shows an example 300 of an editing interface for creating a prompt for a prompt library according to some embodiments of the present disclosure. Example 300 includes an area 310 for editing the prompt content, and area 310 may present the prompt content. It should be noted that here only the prompt (including the editing block and the non-editing block) only includes text for example description. In actual application, the prompt may include any appropriate type of content such as images and codes. Different contents may correspond to different types of editing blocks. For example, text content may correspond to text editing blocks, image content may correspond to image editing blocks, application program interface (API) description may correspond to API editing blocks, and so on. The triggering method, creation method, etc. of different types of editing blocks may be the same or different.

Specifically, area 310 may present at least one editing block (e.g., editing block 311, editing block 312, editing block 313, editing block 314, and editing block 315) and the content of non-editing blocks (e.g., the text “You will play a character role”, the text “The following are detailed settings about this role, please construct your answer based on this information”, the text “Basic information of the character”, the text “Role background and context”, etc.). The assistant creation platform 110 may present the content of non-editing blocks in the visual style of regular text, and may present editing blocks in a visual style of bold, italic, different colors, different fonts, and/or adding borders. Please understand that the presentation of the visual style of the editing blocks in the drawing is only an example, and the visual style to be used may be selected according to actual needs.

In some embodiments, the assistant creation platform 110 may insert a text editing block (which may be referred to as a second text editing block, for example) at the input cursor of the editing interface in response to detecting a trigger on a text editing block function without at least partial text of the prompt being selected. Continuing to refer to FIG. 3A, the assistant creation platform 110 may present an input cursor 320 and an adding control 301 for a text editing block in area 310. In the absence of receiving a selection of at least partial text of the prompt, the assistant creation platform 110 may determine that a trigger on a text editing block function is detected in response to receiving a trigger on the adding control 301. The assistant creation platform 110 may present the editing interface shown in FIG. 3B.

In FIG. 3B, the assistant creation platform 110 may present an insert text editing block 330 at the input cursor 320. In some embodiments, the assistant creation platform 110 may also display filling guidance text in association with the text editing block 330 (e.g., the text displayed in the text editing block 330 as shown, “Please input the prompt text when content of the editing block is empty.”).

In some embodiments, the assistant creation platform 110 may also present a text input interface 340 for the text editing block 330 in association with the text editing block 330. The text input interface 340 includes at least one of an input area 342 (which, for example, may be referred to as a second input area corresponding to a second text editing block) or an input area 344 (which, for example, may be referred to as a first input area corresponding to a second text editing block).

In some embodiments, the assistant creation platform 110 may also provide filling guidance text in the text editing block in response to receiving a filling guidance text for a given text editing block in the input area 342, when there is no filled text in the given text editing block. In some embodiments, the assistant creation platform 110 may replace the filled text in the given text editing block with the specified text in response to receiving the specified text in the input area 344. That is, in the case where the specified text input by the user is not received via the input area 344, the assistant creation platform 110 may present the guide text in the input area 342 in the text editing block 330. In the case where the specified text input by the user is received via the input area 344, the assistant creation platform 110 preferentially presents the specified text in the text editing block 330.

In some embodiments, when the text input interface 340 is presented in association with the text editing block 330, it may be determined that the text editing block 330 is in a text editing state, and when the text input interface 340 is not presented, it may be determined that the text editing block 330 is not in a text editing state. The assistant creation platform 110 may present the text editing block 330 in the text editing state and the text editing block 330 not in the text editing state in different visual styles. As an example, also referring to FIG. 3C, the assistant creation platform 110 may present the text editing block 330 in FIG. 3B and in FIG. 3C in different visual styles.

In some embodiments, the assistant creation platform 110 may also, in response to detecting a trigger on a text editing block function with at least partial text of the prompt being selected, configure a text editing block (which may be referred to as a first text editing block, for example) at the location of the selected at least partial text, where the text editing block may be filled with at least partial text.

Referring to the editing interface shown in FIG. 3D, in some embodiments, the assistant creation platform 110 may directly present a window 360 including at least one operation control in response to the text “this role” of the non-editing block in the prompt being selected. In other embodiments, 110 may present a window 360 including at least one operation control in response to the text “this role” of the non-editing block in the prompt being selected and receiving a triggering operation (such as a right-click operation) for the text “this role”. At least one control in window 360 includes at least an editing control 362. In response to the editing control 362 being triggered, the assistant creation platform 110 may configure the text editing block 350 based on the text “this role”, and the text editing block 350 is filled with the text “this role”.

In some embodiments, the assistant creation platform 110 may also present a text input interface 370 for the text editing block 350 in association with the text editing block 350. The text input interface 370 includes at least one of an input area 372 (which may be referred to as a second input area corresponding to the first text editing block, for example) or an input area 374 (which may be referred to as a first input area corresponding to the first text editing block, for example).

Similarly, the assistant creation platform 110 may also respond to receiving a filling guidance text for a given text editing block in the input area 372, and the filling guidance text is displayed in response to no text being filled in the given text editing block. The assistant creation platform 110 may respond to receiving a specified text in the input area 374 and replace the filled text in the given text editing block with the specified text. That is, the assistant creation platform 110 may respond to receiving the specified text in the input area 374 and replace the text “this role” in the given text editing block with the specified text.

Similarly, in the absence of receiving specified text input by the user via the input area 374, the assistant creation platform 110 may present the guide text in the input area 372 in the text editing block 350. In the absence of receiving specified text input by the user via the input area 374, the assistant creation platform 110 prioritizes presenting the specified text in the text editing block 350.

Similarly, when the text input interface 370 is presented in association with the text editing block 350, it may be determined that the text editing block 350 is in the text editing state, and when the text input interface 370 is not presented, it may be determined that the text editing block 350 is not in the text editing state. The assistant creation platform 110 may present the text editing block 350 in the text editing state and the text editing block 350 not in the text editing state in different visual styles. As an example, also referring to FIG. 3E, the assistant creation platform 110 may present the text editing block 350 in FIG. 3D and in FIG. 3E in different visual styles.

The assistant creation platform 110 may determine the content filled in the editing block as a part of the prompt in response to confirmation on the editing of the prompt. For example, referring to the example 300 shown in FIGS. 3A to 3E, the example 300 may include a confirmation control for the prompt. The assistant creation platform 110 may, for example, determine that the confirmation on the editing of the prompt is received in response to receiving a trigger on the confirmation control, and then determine the content filled in the editing block as a part of the prompt.

Referring to FIGS. 4A and 4B, FIGS. 4A and 4B show an example 400 of a configuration area for receiving a prompt according to some embodiments of the present disclosure. The configuration area here may be a configuration area for receiving a prompt input in a natural language in a user interface for creating a digital assistant 120. The prompt is presented in area 410 of example 400. The assistant creation platform 110 may also configure a text editing block based on at least partial text at the location of the selected at least partial text in response to detecting a trigger on the text editing block function with at least partial text of the prompt being selected, and the text editing block here may be filled with at least partial text.

Referring to the editing interface shown in FIG. 4A, in some embodiments, the assistant creation platform 110 may directly present a window 420 including at least one operation control in response to the text “XXXXXXXX” of the non-editing block in the prompt being selected. In other embodiments, 110 may present a window 420 including at least one operation control in response to the text “XXXXXXXX” of the non-editing block in the prompt being selected and receiving a triggering operation (such as a right-click operation) for the text. At least one control in window 420 includes at least an editing control 422. In response to the editing control 422 being triggered, the assistant creation platform 110 may configure the text editing block 412 based on the selected text, and the text editing block 412 is filled with the selected text “XXXXXXXX”.

In some embodiments, the assistant creation platform 110 may also present a text input interface 430 for the text editing block 4120 in association with the text editing block 4120. In the example of FIG. 4A, the text input interface 430 includes at least one of an input area 432 (which may be referred to as a second input area corresponding to the text editing block 412, for example) or an input area 434 (which may be referred to as a first input area corresponding to the text editing block 412, for example). The text “XXXXXXXX” 412 selected in the current prompt may be presented in the input area 434 by default.

430 is presented in association with the text editing block 412, it may be determined that the text editing block 412 is in the text editing state, and when the text input interface 430 is not presented, it may be determined that the text editing block 412 is not in the text editing state. The assistant creation platform 110 may present the text editing block 412 in the text editing state and the text editing block 412 not in the text editing state in different visual styles. As an example, the assistant creation platform 110 may present the text editing block 412 in FIG. 4A and in FIG. 4B in different visual styles.

In some embodiments, the assistant creation platform 110 can, in response to detecting a trigger on an application program interface (API) editing block function, insert an API editing block (which may be referred to as a first API editing block) at a selected location of a prompt, and the API editing block may be filled with identification information of a predefined API. The identification information of the API may include any appropriate information such as the name of API, image logo, brief description, etc. APIs that may be associated with specific functions may include plug-ins, knowledge bases, workflows, image streams, and the like. During the function execution, one or more tasks or operations to be performed may require calling an associated API to complete.

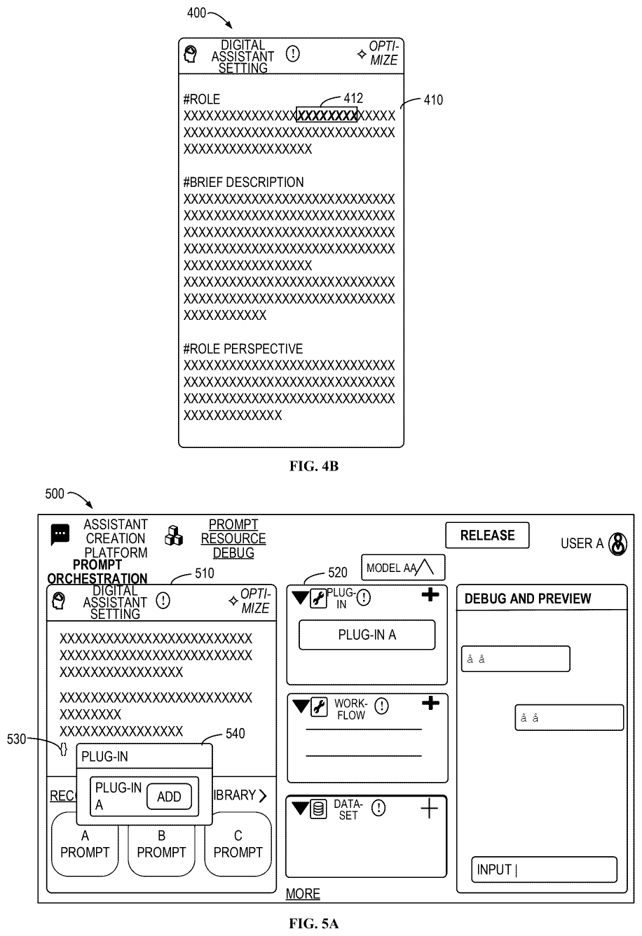

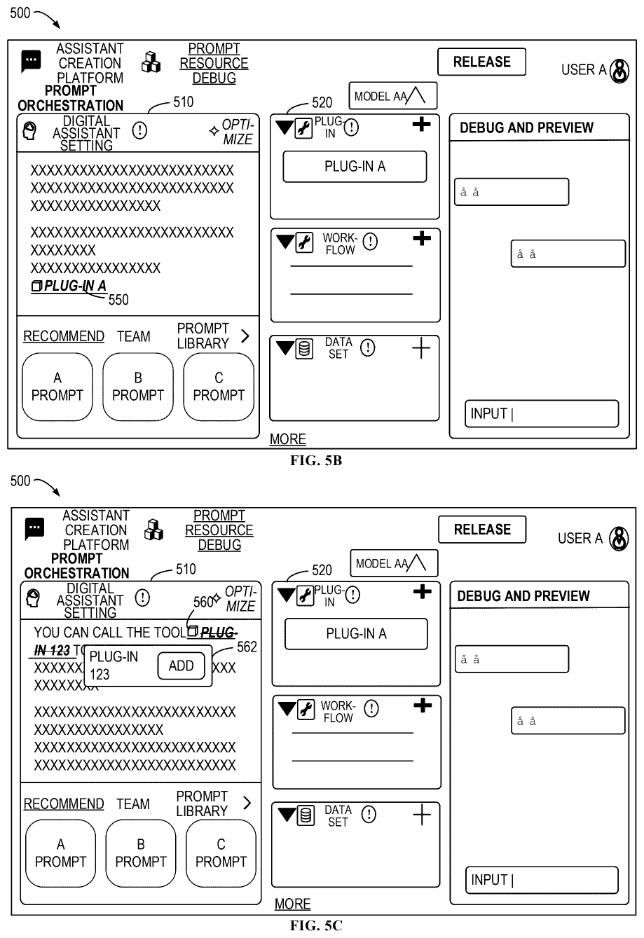

Referring to FIGS. 5A to 5D, FIGS. 5A to 5D show an example 500 of an editing interface for a target function according to some embodiments of the present disclosure. Referring to FIG. 5A, the example 500 includes at least a configuration area 510 for receiving a prompt input in a natural language and an area 520 for API (e.g., plug-in) configuration. In example 500, the assistant creation platform 110 can, for example, determine that a trigger on an API editing block function is detected in response to receiving a predetermined symbol 530 (e.g., a curly bracket {}) input by a user at the configuration area 510. In this case, the assistant creation platform 110 may determine that a trigger on an API editing block is detected, and insert an API editing block at the predetermined symbol 530. It may be understood that the assistant creation platform 110 may also determine that a trigger on an API editing block function is detected in response to any other appropriate triggering method. For example, the assistant creation platform 110 may determine that a trigger on an API editing block function is detected in response to receiving a right-click operation.

The assistant creation platform 110 may present at least one fillable API, where at least one API is associated with the target function. As an example, at least one API associated with the target function may be presented at area 520 of example 500. For example, if plug-in A is associated with the target function, the identification of plug-in A may be presented at area 520. The assistant creation platform 110 may present a window 540 at a predetermined symbol 530, and the window 540 may present identification information of plug-in A and an adding control for plug-in A.

The assistant creation platform 110 may fill the identification information of the first API into the first API editing block in response to detecting the selection of the first API from the at least one API. For example, the assistant creation platform 110 may fill the identification information of plug-in A into the first API editing block in response to receiving a trigger on an adding control for plug-in A in window 540 and determining that a selection of plug-in A is received. The assistant creation platform 110 may then present the example 500 shown in FIG. 5B. The example 500 shown in FIG. 5B presents an API editing block 550, and the API editing block 550 is filled with the identification information of plug-in A.

In some embodiments, the prompt presented in the editing interface of the target function may be a prompt determined from a prompt library. Therefore, there is a situation in which the prompt includes an API editing block (which may be referred to as a second API editing block) filled with identification information of the second API, and the second API is not associated with the target function. In this case, the assistant creation platform 110 may present the identification information of the second API as a visual style corresponding to a disabled state in response to the second API not being associated with the target function. The visual style corresponding to the disabled state may be grayed out, for example, but this is merely exemplary and the present disclosure does not limit this. For example, referring to FIG. 5C, the prompt includes an API editing block 560. Since the second API (i.e., plug-in 123) is not associated with the target function, the assistant creation platform 110 may present the identification information of plug-in 123 as a visual style corresponding to the disabled state by superimposing a deletion line on the API editing block.

The assistant creation platform 110 may present a fillable second API in response to detecting a trigger on the API editing block 560, and in response to detecting a selection of the second API, present the identification information of the plug-in 123 as a visual style corresponding to the enabled state. Continuing to refer to FIG. 5C, the assistant creation platform 110 may present a window 562 in response to detecting a trigger on the API editing block 560, and the window 562 presents a fillable plug-in 123 and an adding control for the plug-in 123. The assistant creation platform 110 may determine that a selection of the plug-in 123 is received in response to receiving a trigger on an adding control for the plug-in 123, and then present the example 500 shown in FIG. 5D. At this time, the assistant creation platform 110 associates the plug-in 123 with the target function, and the assistant creation platform 110 may present the plug-in 123 in the area 520. The plug-in 123 associated with the target function is switched to the enabled state at this time. The assistant creation platform 110 may also present the identification information of the plug-in 123 as a visual style corresponding to the enabled state by canceling the presentation of the strikethrough.

In some embodiments, the assistant creation platform 110 may also present the annotation content in a first visual style in response to determining that partial content input in the editing interface is marked as annotation content, and the annotation content here will not be input into the machine learning model. The assistant creation platform 110 may determine that the annotation content is received in response to receiving a specified symbol, a specified text, etc. The assistant creation platform 110 may also present, in a second visual style, at least partial predetermined symbols of code in a computer language in response to determining that partial content input in the editing interface is the code. The computer language may include any appropriate computer language such as Jinja, Markdown language, etc. Which content in the code is to be highlighted in the second visual style may be pre-configured. The first visual style and the second visual style may be different visual styles, or they may be the same visual style.

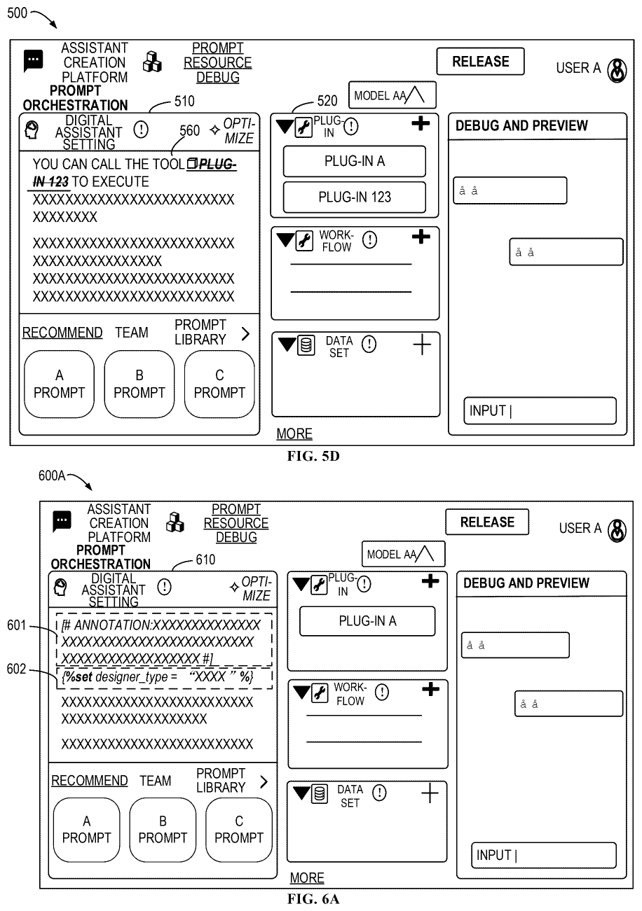

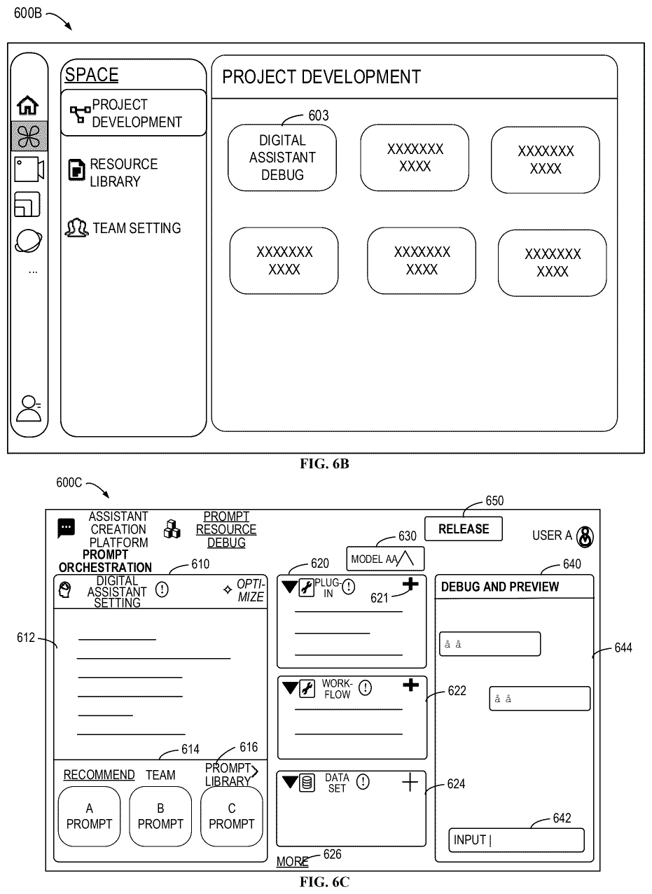

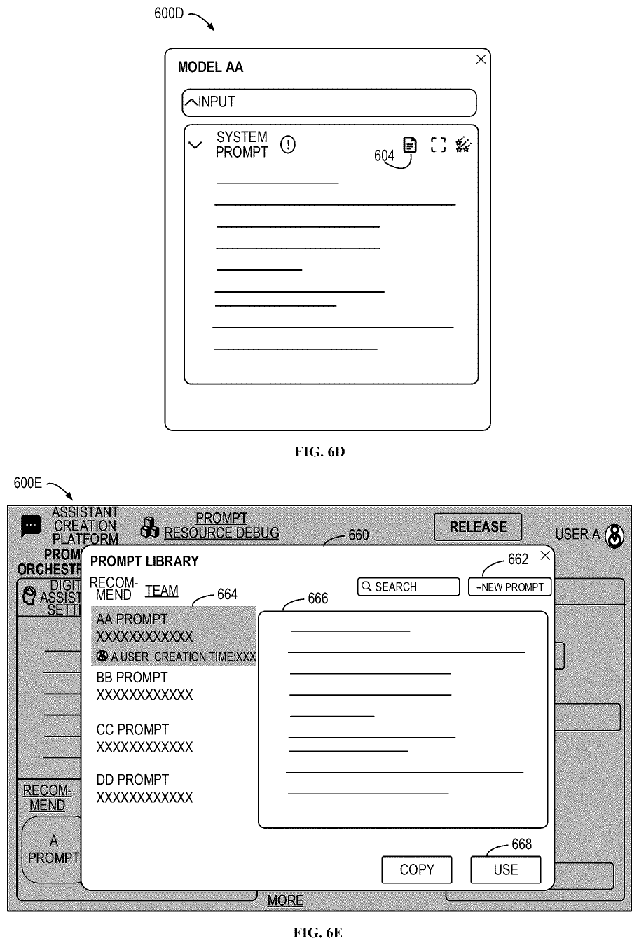

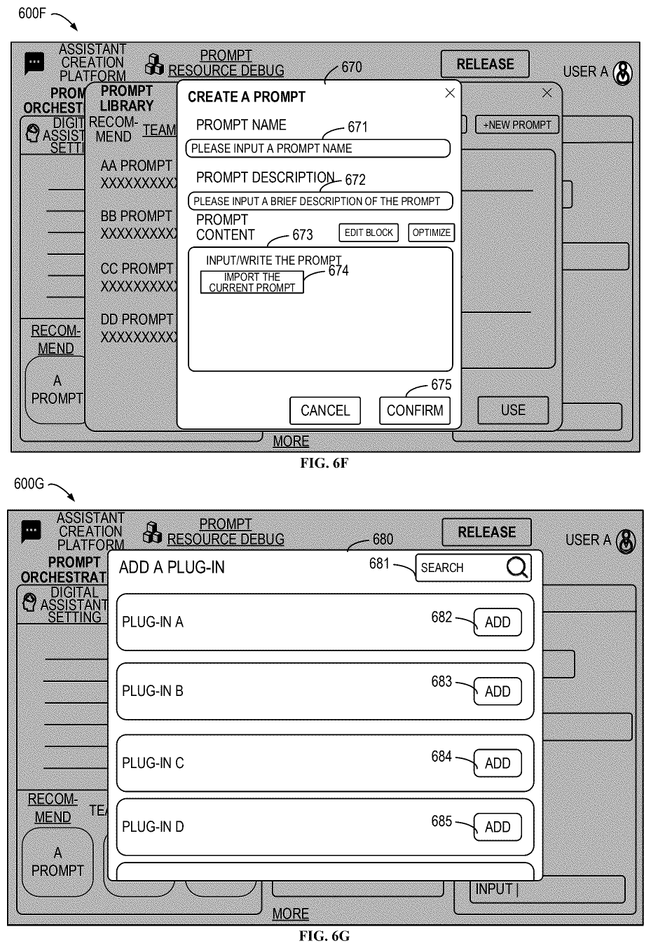

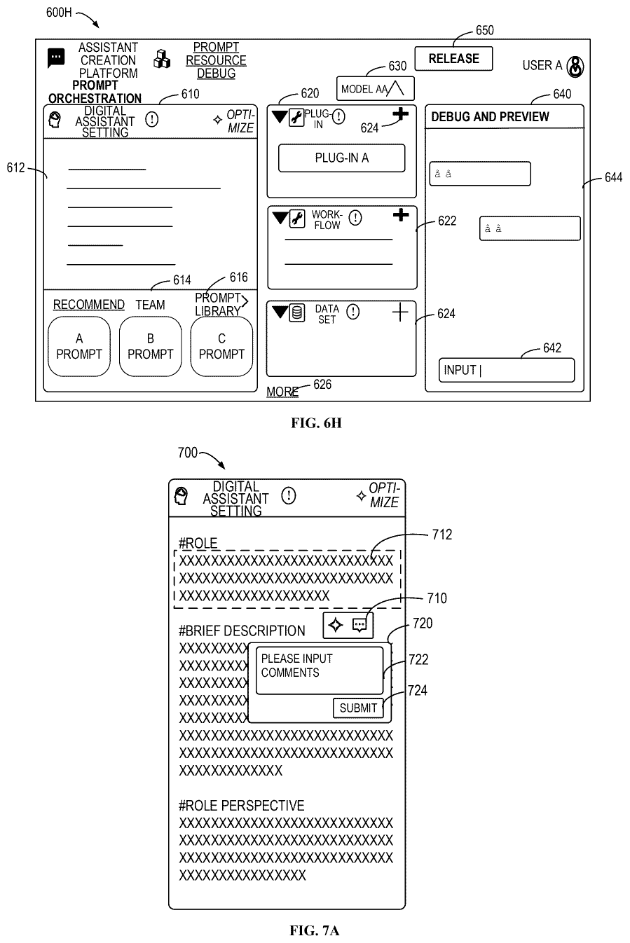

Referring to FIG. 6A, FIG. 6A shows an example 600 of an editing interface according to some embodiments of the present disclosure. Example 600 includes an area 610 for receiving a prompt input in a natural language. In example 600, the assistant creation platform 110 may present the annotation content in area 601 in a visual style such as italic text and gray font in response to determining that the content 601 is identified as annotation content. The assistant creation platform 110 may also present the symbol “%” in the content 602 and the “set” in the code in a bold visual style in response to determining that the content 602 is code in a computer language.

It is briefly mentioned above that a prompt associated with specific functions or newly created a prompt may be added to the prompt library. In the process of adding, the editing block function may be applied to the prompt. The following will discuss in more detail how to add a prompt in the prompt library and how to apply a prompt in the prompt library.

In some embodiments, the assistant creation platform 110 may present an example 600B of the project development interface shown in FIG. 6B. Example 600B includes a debug control 603 for debugging a created digital assistant. The assistant creation platform 110 may present an editing interface for a target function in response to receiving a trigger on the debug control 603. As mentioned above, the target functions include digital assistants, workflow nodes, and the like. If the target function includes a digital assistant, the editing interface for the target function may include a creation interface for the digital assistant. For example, the user 105 may initiate a creation request to the assistant creation platform 110 as needed. In response to receiving the creation request, the assistant creation platform 110 presents a user interface for creating a digital assistant.

Example 600C shown in FIG. 6C shows an example of a user interface for creating a digital assistant. User 105 may configure the digital assistant to be created (assuming it is the digital assistant 120 shown in FIG. 1) in example 600C. Different from creating a digital assistant by writing code, in an embodiment of the present disclosure, the interface for creating a digital assistant is designed to include at least one configuration area for receiving configuration information of the digital assistant, and each configuration area is defined as receiving a type of configuration information required for building a digital assistant.

The user interface for creating a digital assistant includes at least a configuration area 610 for receiving a prompt input in natural language, which includes an input box for receiving a prompt input by the user in natural language (also referred to as prompt input). The prompt input will be provided to the machine learning model, and the reply of the digital assistant 120 to the user will be determined based on the output of the machine learning model. In other words, the digital assistant 120 to be created will use the machine learning model to determine the user needs corresponding to the user input, and provide a reply to the user based on the output of the machine learning model.

In some embodiments, the configuration area 610 may include an area 612 and an area 614. Area 612 may be used to present the received prompt. Area 614 is used to present the identification of the prompt historically created or historically acquired by the user. In response to receiving the user's selection of an identification of certain prompt in area 614, the assistant creation platform 110 may determine the prompt corresponding to the identification as the prompt for the machine learning model, and present the prompt in area 612. Area 614 may include an entry 616 for a prompt library. In response to receiving a trigger on the entry 616 for the prompt library from the user, the assistant creation platform 110 may determine to present the interface corresponding to the prompt library.

In some embodiments, the assistant creation platform 110 may also present a details page corresponding to the workflow node in response to detecting that the user 105 clicks on a workflow node in the workflow corresponding to the machine learning model. Example 600D shown in FIG. 6D shows an example of a details interface. Details page 600D includes an entry 604 for a prompt library. The assistant creation platform 110 may determine that a trigger on the prompt library is received in response to receiving a trigger on the entry 604, and then present an interface corresponding to the prompt library.

Referring to FIG. 6E, the example 600E shown in FIG. 6E includes an interface 660 corresponding to a prompt library. The interface 660 may present multiple prompts that the user may use, and the multiple prompts may include a prompt created by the user in history, and may also include a prompt created by other users and shared with the user (e.g., a prompt in a team). The assistant creation platform 110 may also present prompts such as AA prompt 664, BB prompt, CC prompt, etc. included in the prompt library in interface 660. In some examples, the assistant creation platform 110 may also present the identification information, creation time, etc. of the creator of at least one prompt.

In some examples, the assistant creation platform 110 may present at least one prompt in a list form on the left side of the prompt library presentation interface 660. However, this is merely exemplary and the present disclosure does not limit this. Further, if the assistant creation platform 110 detects that the user 105 clicks the AA prompt 664, the content of the AA prompt 664 may be presented on the right side of the prompt library presentation interface 660 for the user 105 to preview.

In some embodiments, if the assistant creation platform 110 detects a trigger on the prompt library, at least one prompt may be presented. Each prompt is classified into at least one type of multiple types. In some examples, the assistant creation platform 110 may display at least one prompt according to different types. The type of prompt may be configured according to various criteria, such as some prompts may be divided into recommended prompts and other prompts. For example, the assistant creation platform 110 may present at least one prompt recommended by the user, and may also present at least one prompt created by the developer and/or the team to which the developer belongs. In some examples, the assistant creation platform 110 may present at least one prompt recommended by the user 105 based on the information of the digital assistant/workflow node currently being created by the user 105 (e.g., the name of the digital assistant/workflow node). In some embodiments, the type of prompt may also be classified based on the scenario used by the prompt, and/or the function targeted. For example, the prompt of the role avatar class may be applicable to the digital assistant or workflow node to generate the role avatar, and the prompt of the efficiency class tool may be applied to the digital assistant or workflow node of the efficiency tool class. In addition, different prompt types may also be divided according to the functions being created (for example, plug-ins, workflows, databases, knowledge bases to be called), etc.

In some embodiments, the assistant creation platform 110 may display at least one prompt included in the prompt library according to different types. In some examples, the assistant creation platform 110 may classify the prompt in the prompt library according to the source of the prompt (for example, from the recommendation or from the team to which the user 105 belongs). In some examples, the assistant creation platform 110 may also classify the prompt in the prompt library into several categories according to the identification information of the prompt. Such classification and display methods facilitate users to quickly locate the desired prompt.

In some embodiments, if the assistant creation platform 110 receives an application request for a first prompt in at least one prompt, the first prompt may be inserted into an area corresponding to the prompt editing in the editing interface. For example, in example 600E, the assistant creation platform 110 may insert the AA prompt 664 into an area 666 corresponding to the prompt editing in the interface 660 in response to detecting the user 105′s selection of the AA prompt 664 and the selection of the “use” control 668.

Subsequently, the assistant creation platform 110 creates a first function based on at least the first prompt or the edited first prompt. In some examples, the assistant creation platform 110 creates a digital assistant 120 or a workflow node based on at least the AA prompt 664. In other examples, the assistant creation platform 110 may also create a digital assistant 120 or a workflow node based on at least the edited AA prompt 664. It is understandable that after choosing to insert the AA prompt 664, the user 105 may also write the AA prompt 664 based on the AA prompt 664.

In some embodiments, the first prompt or the edited first prompt may be input into a first machine learning model associated with a first function, and the output of the first function is determined based on the output of the first machine learning model. It is understandable that the AA prompt 664 or the edited AA prompt 664 may be associated with a function based on the first machine learning model (e.g., a digital assistant 120 or a workflow node). In this way, the digital assistant 120 or the workflow node may process the input of the function with the help of the first machine learning model, and provide the output of the function based on the output of the first machine learning model. For example, for a digital assistant based on a machine learning model, the first machine learning model may determine the user needs corresponding to the user input based on the AA prompt 664 or the edited AA prompt 262, and output it, which will be used to determine a reply to the user.

Interface 660 includes a creation control 662 for a prompt. The assistant creation platform 110 may present an example 600F as shown in FIG. 6F in response to receiving a trigger on a creation control 662 from a user. Example 600F includes an editing interface 670 (also referred to as a creation interface for a prompt) for creating a prompt for a prompt library. Interface 670 includes an area 671 for editing a prompt name, an area 672 for editing a prompt description, and an area 673 for editing prompt content. The prompt description may indicate the function, effect, etc. of the prompt, and the prompt content may include the full text of the prompt. Area 673 may also include an import control 674. The assistant creation platform 110 may present the prompt in area 612 of the configuration area 610 in area 673 in response to receiving a trigger on the import control 674. Interface 670 may also include a confirmation control 675, and the assistant creation platform 110 may create a prompt based on the content presented in areas 671, 672, and 673 in response to receiving a trigger on the confirmation control 675.

Referring back to FIG. 6C, in some embodiments, the user interface for creating the digital assistant 120 may also include a second configuration area for receiving a configuration of at least one processing component. The configuration of the processing component indicates at least one processing component that the digital assistant 120 may use when processing a user request. In some embodiments, after having the configuration of the processing component, when the created digital assistant 120 interacts with the user, the configuration of the processing component may be provided to the model so that the model may determine which processing component/processing components need to be used to complete the processing of the user input, and then determine the reply to the user.

Each processing component may be understood as a tool that the digital assistant 120 may call when processing a user request, and each processing component may perform a corresponding function or service. The types of processing components may be very diverse, and may be selected, configured or modified by the user 105 from existing processing components, or the user 105 may be allowed to customize one or more processing components.

In some embodiments, the second configuration area may include an area for API (e.g., plug-in) configuration, such as area 620 shown in FIG. 6C. In this area, at least one plug-in used by the digital assistant 120 may be selected or customized by the user. Each plug-in is configured to perform a corresponding function. For example, a search plug-in may perform a data search function; a browser plug-in may provide a web browsing function; a music plug-in may provide a music search and playback function, and so on.

A plug-in may be considered as an atomic capability of the digital assistant 110. The digital assistant 120 may call one or more plug-ins to process user requests. In some embodiments, the assistant creation platform 110 may provide a plug-in library for the user 105 to select developed plug-ins from. In some embodiments, alternatively or additionally, the assistant creation platform 110 may provide a plug-in definition interface for the user 105 to define a plug-in with a specific function as needed.

Area 620 may include an adding control 621 for a plug-in. The assistant creation platform 110 may present the example 600G shown in FIG. 6G in response to receiving a trigger on the adding control 621. Example 600G includes an interface 680 of a plug-in library. Interface 680 may present all plug-ins in the plug-in library (e.g., plug-ins A, B, C, D, etc.). To facilitate users to quickly look up desired plug-ins, interface 680 may also include a search box 681. The assistant creation platform 110 may receive user input via the search box 681 and look up corresponding plug-ins from the plug-in library based on the user input. Interface 681 may also include an adding control corresponding to each plug-in, such as an adding control 682 corresponding to plug-in A, an adding control 683 corresponding to plug-in B, an adding control 684 corresponding to plug-in C, an adding control 685 corresponding to plug-in D, and the like.

The assistant creation platform 110 can, in response to receiving a trigger on an adding control, associate the plug-in corresponding to the adding control to the digital assistant. For example, the assistant creation platform 110 may associate plug-in A to the digital assistant in response to receiving a trigger on the adding control 682. This process may be considered as associating the API to the target function. The assistant creation platform 110 can, for example, present example 600H shown in FIG. 6H in response to plug-in A being associated with the digital assistant. An identification corresponding to plug-in A may be presented in area 620 of example 600H to indicate that plug-in A is associated with the digital assistant.

Referring back to FIG. 6C, in some embodiments, the second configuration area may include an area for workflow configuration, such as area 622 shown in FIG. 6C. In this area, the user may select or customize at least one workflow to be executed by the digital assistant 120. The workflow may not only be input in a natural language in the prompt, but also provide a workflow entry to allow the user 105 to select an existing workflow, or define a workflow through a dedicated interface.

In some embodiments, the second configuration area may include an area for workflow configuration, such as area 624 shown in FIG. 6C. In this area, the user may select at least one data set, and the digital assistant 120 uses at least one data set to determine a reply to the user. Here, a “data set” may also be referred to as a “knowledge base.” When determining a reply to the user, the digital assistant 120 may retrieve the corresponding knowledge from the configured data set for reply determination. In some embodiments, the assistant creation platform 110 may allow the user 105 to select from existing data sets, upload a local data set, or specify an online data set, etc. to configure the data set of the digital assistant 120.

It is understood that the second configuration area may also include other areas, such as an area for workflow configuration, an area for configuring persistent storage information, an area for configuring tasks, and the like. The present disclosure is not limited to this. Example 600C may also present a control 626. The assistant creation platform 110 may, for example, present more second configuration areas in response to receiving a triggering operation on the control 626.

As mentioned above, the digital assistant 120 may use a machine learning model to understand user requests and to determine a reply to the user. In some embodiments, the machine learning model used by the digital assistant 120 may be a default, without the need for configuration by the creator. In some embodiments, in the process of creating a digital assistant 120, the creator may be allowed to select the machine learning model to be used. A fourth configuration area may be provided in the user interface for creating a digital assistant for receiving a selection of a machine learning model. The selected machine learning model is called to determine the reply to the user in the digital assistant 120. As shown in FIG. 6C, example 600C also includes an area 630 for configuring a machine learning model, in which the user 105 may be allowed to select the machine learning model to be used.

The above discusses the configurable processing components in the digital assistant creation process. In specific applications, the assistant creation platform may provide more, fewer or different configurations of processing components for the creator of the digital assistant to select or configure as needed.

In some embodiments, in order to allow the user 105 who creates the digital assistant to conveniently test the operating effect of the created digital assistant 120 during the creation process, a debugging area for the digital assistant may also be provided in the user interface, such as the debugging area 640 shown in FIG. 6C. The debugging area 640 includes an input area 642 for receiving a debugging request for the digital assistant 120, and also includes a presentation area 644 for providing debugging results for the debugging request (as well as providing received debugging requests). The debugging area 640 may be configured in the form of an interactive window to simulate the interactive interface viewed by the interactive user of the digital assistant 120.

During the debugging process, the debugging results presented in the debugging area 640 may be determined based on the received debugging request and the current configuration information for the digital assistant 120 in the user interface. The user 105 may determine whether the actual operating results of the digital assistant 120 meet expectations based on the debugging results, and whether to continue to modify the configuration information, or whether to release the digital assistant. In some embodiments, for each debugging, in addition to providing the debugging results, the underlying operating process of the digital assistant 120 to determine the debugging results may also be provided, such as the call to the machine learning model, the processing process of the machine learning model, one or more plug-ins used, etc. This may facilitate the user 105 to more quickly determine whether the currently configured digital assistant meets expectations.

By using machine learning models and setting information to understand user needs and using processing components to execute user needs, the digital assistant 120 will be able to interact with the user and respond to user requests. The user interface for creating a digital assistant is templated to provide various configuration areas for receiving configuration information of the digital assistant 120, and the user 105 may complete the customization of the digital assistant 120 while performing complex configuration and coding.

In some embodiments, the assistant creation platform 110 may provide a creation portal for a digital assistant in any appropriate user interface. The user may access the user interface for creating a digital assistant by triggering the creation portal. Based on the input of the user 105 on the user interface for creating a digital assistant, the configuration information received in the user interface may be obtained. The configuration information includes at least the prompt received in the configuration area 610. After completing the configuration, the user 105 is also allowed to release the created digital assistant. In response to receiving a release request, the assistant creation platform 110 releases the digital assistant 120 based on the configuration information received in the user interface for interaction with the user. As shown in FIG. 6C, the user interface presents a release control 650. In response to detecting a trigger on the release control 650, the assistant creation platform 110 receives the user's release request and releases the digital assistant 120 based on the configuration information received in the user interface.

In some embodiments, the created digital assistant 120 may be released to a default platform for operation. In some embodiments, candidate platforms may be provided for user selection. In response to receiving a releasing request, the assistant creation platform 110 may provide at least one candidate platform, each of the at least one candidate platform supports the operation of the digital assistant 120. In response to receiving confirmation of a target platform in at least one candidate platform, the digital assistant 120 is released to the target platform, such as the assistant application platform 130 in FIG. 1.

The above describes the creation process of the digital assistant and the editing process of the prompt of some embodiments of the present disclosure. In the embodiments of the present disclosure, the assistant creation platform provides full support for the formation of the digital assistant, so that users may create a prompt and a digital assistant conveniently, quickly, flexibly and freely.

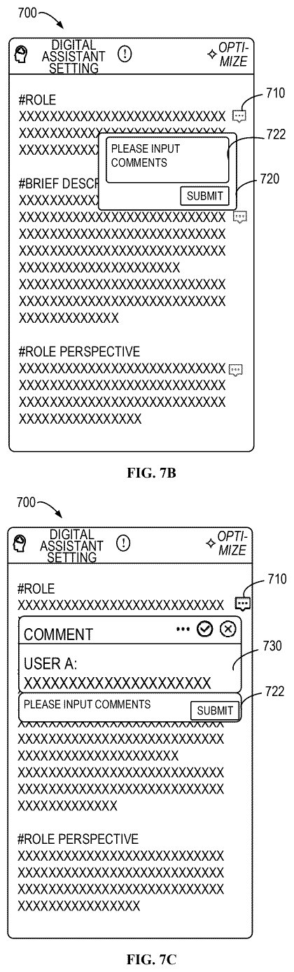

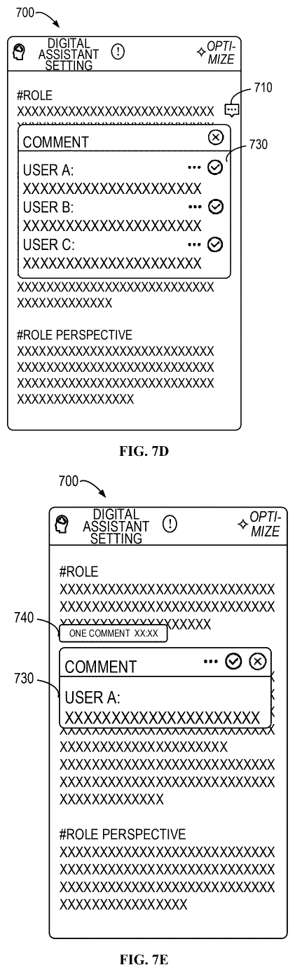

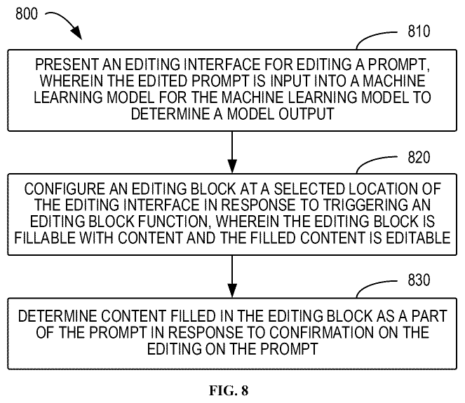

In some embodiments, in the editing interface of the function based on the prompt, for the prompt area, a comment function to the prompt may also be provided. For example, in the editing interface of the prompt in the prompt library, or in the editing interface to a specific function (for example, a digital assistant or a workflow node), a comment function to the prompt may be provided. This is because different users may develop and maintain the same function, and providing the comment function helps these users to share opinions on the prompt, provide annotations to the prompt, and help users better understand the function of the prompt. The comment function to the prompt will be discussed below with reference to FIGS. 7A to 7E.

FIGS. 7A to 7E show an example interface 700 for a comment function on a prompt according to some embodiments of the present disclosure. The comment function here is sometimes also referred to as an annotation function. FIGS. 7A to 7E show that a comment function on a prompt is provided in a prompt input area for a digital assistant. It should be understood that a comment function on a prompt may be provided during the editing process of a prompt for other functions (e.g., workflow nodes), or during the process of adding a new prompt to a prompt library, or when viewing a prompt in a prompt library.

In some embodiments, in response to a comment trigger on at least partial content of the prompt, the assistant creation platform 110 presents a user interface for comment input. In some embodiments, in response to at least partial content of the prompt being selected, a comment control is presented, and in response to the trigger on the comment control, a user interface for comment input is presented. The user interface for comment input includes an input control. The input control for comment input may include an input box, or may also include one or more other input controls that support voice input, image input, file import, etc. Comments on the selected at least partial content may be received via an input control, such as an input box.

As shown in FIG. 7A, in the prompt input area of the digital assistant, in response to partial content 712 in the prompt being selected, a panel of operable controls may be presented, wherein at least a comment control 712 is provided. In response to detecting a trigger on the comment control 710, a user interface 720 for comment input is presented, which includes an input box 722. The user may input comment content for the partial content 712 in the input box 722. In response to detecting a confirmation of the comment content, such as a trigger on the “submit” control 724 in FIG. 7A (or a confirmation triggered by other means), the received comment content may be associated with the selected partial content 712.

In some embodiments, the comment control for triggering the comment function may be presented in association with the unit content of the prompt, for example, the comment control may be presented in association with each paragraph or each line of the prompt content. As shown in FIG. 7B, the comment control 710 is presented at each paragraph of the prompt. The comment control may be presented fixedly, or the comment control may be presented after detecting a hover operation on the part (for example, the mouse hovers over the partial content). Similar to the example of FIG. 7B, by triggering the comment control, a user interface for comment input may be presented for the user to input the comment content.

In some embodiments, the comment function of the prompt may be determined based on the role of the user. For example, the creator of the prompt in the digital assistant, workflow node or prompt library may add comments to the prompt, and the range of users who may comment on the corresponding prompt may be configured.

In some embodiments, comments associated with at least partial content in the prompt may be presented to the user. In some embodiments, comments associated with at least partial content in the prompt may be fixedly presented in a specific comment display area. In some embodiments, comments associated with at least partial content in the prompt may be in a retracted state, and are unfolded to be presented to the user after detecting the trigger on the comment viewing. As shown in FIG. 7C, by clicking the comment control 710 or by hovering the comment control 710, a comment panel 730 may be presented, wherein the comments on the associated prompt content are presented. In some embodiments, if there are multiple comments on at least partial content of the prompt, the comments may also be presented in a retracted state, and may be presented to the user after being triggered. As shown in FIG. 7D, after triggering the comment control 710, multiple comments may be presented in the comment panel 730. In some embodiments, a comment control for triggering comment input or other comment input triggering methods may also be provided in the comment panel, thereby triggering the input control for presenting the comment. As shown in FIG. 7C, while presenting other comments, the input box 722 of the comment may also be presented so that the current user may input the comment content.

In some embodiments, when the comment is in the collapsed state, summary information of the comment on a certain content part in the prompt may also be provided. The summary information of the comment may indicate the number of comments, the identities of at least partial users who issued the comments, partial content of the comment, and so on. In this way, the user may be informed that there are comments on a certain part of the prompt without expanding the comment details, and may also be informed of at least partial information of the comment. As shown in FIG. 7E, a comment viewing control 740 is provided in the prompt part associated with the comment. By triggering the comment viewing control 740, a comment panel 730 may be presented, in which comments on the content of the associated prompt are presented.

In some embodiments, the presentation of comments may also be determined based on the role of the user. For example, users who may access the prompt may be configured to be able to access the comments related to the prompt. In some embodiments, it is also possible to support editing of existing comments in the prompt, including modification, deletion, etc. of the comment content. The editing function for the comment may also be determined based on the role of the user. For example, users who have the editing ability for the prompt may be configured to support the editing function of the comment equally.

In some embodiments, during the prompt editing process, the annotations and comments associated with the prompt will not be used to construct the prompt input into the machine learning model. In some embodiments, when creating a digital assistant or workflow, adding annotations/comments may enable other developers of the digital assistant or workflow to quickly understand the logic of the prompt, thereby improving development efficiency. Furthermore, after the prompt with added annotations/comments is saved in the prompt library, other developers may also quickly understand the logic of the prompt when reusing the prompt.

It should be noted that the various visual styles mentioned above may include any appropriate visual styles such as highlighting, bolding, italicizing, underlining, etc. The visual styles for different contents in different states may be pre-set, and the present disclosure does not limit the specific visual styles.

In summary, according to the embodiments of the present disclosure, an editing block may be presented in the prompt, and the editing block may be filled with content and the filled content is editable. This may facilitate the user to edit the editing block to modify the prompt. This helps to improve the efficiency of prompt editing.

FIG. 8 shows a flow chart of a method 800 for editing a prompt according to some embodiments of the present disclosure. The method 800 may be implemented at the assistant creation platform 110. The method 800 is described below with reference to FIG. 1.

In box 810, the assistant creation platform 110 presents an editing interface for editing a prompt, wherein the edited prompt is input into a machine learning model for the machine learning model to determine a model output.

In block 820, the assistant creation platform 110 configures an editing block at a selected location of the editing interface in response to triggering an editing block function, wherein the editing block is fillable with content and the filled content is editable.

In block 830, the assistant creation platform 110 determines content filled in the editing block as a part of the prompt in response to confirmation on the editing on the prompt.

In some embodiments, the visual style of the editing block or the content in the editing block is different from the visual style of the content of the non-editing block in the prompt.

In some embodiments, configuring an editing block at a selected location of a prompt includes: in response to detecting a trigger on a text editing block function with at least partial text of the prompt being selected, configuring a first text editing block based on at least partial text at the location of the selected at least partial text, wherein the first text editing block is filled with at least partial text.

In some embodiments, configuring an editing block at a selected location of a prompt includes: in response to detecting a trigger on a text editing block function without at least partial text of the prompt being selected, inserting a second text editing block at the input cursor of the editing interface, wherein filling guidance text is displayed in association with the second text editing block.

In some embodiments, method 800 also includes: for a given text editing block of the first text editing block or the second text editing block, presenting a text input interface for the given text editing block, the text input interface including at least one of a first input area or a second input area; in response to receiving specified text in the first input area, replacing the filled text in the given text editing block with the specified text; and receiving a filling guidance text for the given text editing block in the second input area, and the filling guidance text is displayed in response to no text being filled in the given text editing block.

In some embodiments, configuring an editing block at a selected location of a prompt includes: in response to detecting a trigger on an application program interface (API) editing block function, inserting a first API editing block at the selected location of the prompt, wherein the first API editing block may be filled with identification information of a predefined API.

In some embodiments, the editing interface includes an editing interface for a target function, the target function executes based on a target machine learning model, and method 800 also includes: in response to detecting a trigger on a first API editing block, presenting at least one fillable API, wherein the at least one API is associated with the target function; and in response to detecting a selection of a first API from the at least one API, filling the identification information of the first API into the first API editing block.

In some embodiments, the editing interface includes an editing interface for a target function, the target function executed based on a target machine learning model, and wherein the prompt includes a second API editing block, the second API editing block is filled with identification information of the second API, and method 800 also includes: in response to the second API not being associated with the target function, presenting the identification information of the second API as a visual style corresponding to a disabled state; in response to detecting a trigger on the second API editing block, presenting a fillable second API; and in response to detecting a selection of the second API, presenting the identification information of the second API as a visual style corresponding to an enabled state.

In some embodiments, method 800 further includes: in response to detecting selection of a predetermined control, determining that trigger on an editing block function is detected; or in response to detecting input of a predetermined symbol in the editing interface, determining that trigger on an editing block function is detected.

In some embodiments, the editing interface includes an editing interface for a target function, the target function executed based on a target machine learning model, and wherein confirming the content filled in the editing block as a part of the prompt includes: in response to confirmation on creation of the target function, confirming the content filled in the editing block as a part of the prompt.

In some embodiments, the editing interface includes an editing interface for creating a prompt for a prompt library, and the method 800 further includes: in response to confirmation on the editing of the prompt, adding the edited prompt to the prompt library.

In some embodiments, method 800 also includes: presenting the annotation content in a first visual style in response to determining that partial content input in the editing interface is marked as annotation content, wherein the annotation content will not be input into the machine learning model; and presenting, in a second visual style, at least partial predetermined symbols of code in a computer language in response to determining that partial content input in the editing interface is the code.

Embodiments of the present disclosure also provide a corresponding apparatus for implementing the above methods or processes. FIG. 9 shows a schematic structural block diagram of an apparatus 900 for prompt editing according to some embodiments of the present disclosure. The apparatus 900 may be implemented in or included in the assistant creation platform 110, for example. The various modules/components in the apparatus 900 may be implemented by hardware, software, firmware, or any combination thereof.

As shown, the apparatus 900 includes an editing interface presentation module 910, which is configured to present an editing interface for editing a prompt, wherein the edited prompt is input into the machine learning model for the machine learning model to determine the model output. Apparatus 900 also includes an editing block configuration module 920, which is configured to configure an editing block at a selected location of the editing interface in response to triggering the editing block function, wherein the editing block may be filled with content and the filled content is editable. The apparatus 900 also includes a prompt determination module 930, which is configured to determine the content filled in the editing block as a part of the prompt in response to confirmation on the editing of the prompt.

In some embodiments, the visual style of the editing block or the content in the editing block is different from the visual style of the content of the non-editing block in the prompt.

In some embodiments, the editing block configuration module 920 is further configured to: in response to detecting a trigger on a text editing block function with at least partial text of the prompt being selected, configure a first text editing block based on at least partial text at the location of the selected at least partial text, wherein the first text editing block is filled with at least partial text.

In some embodiments, the editing block configuration module 920 is further configured to: in response to detecting a trigger on a text editing block function without at least partial text of the prompt being selected, insert a second text editing block at the input cursor of the editing interface, wherein a filling guidance text is displayed in association with the second text editing block.

In some embodiments, the apparatus 900 also includes: a text input interface presentation module, configured to present a text input interface for a given text editing block of the first text editing block or the second text editing block, the text input interface including at least one of the first input area or the second input area; a replacement module, configured to replace the filled text in the given text editing block with the specified text in response to receiving the specified text in the first input area; and a guide text receiving module, configured to receive the filling guidance text for the given text editing block in the second input area, and the filling guidance text is displayed in response to no text being filled in the given text editing block.

In some embodiments, the editing block configuration module 920 is further configured to: in response to detecting a trigger on an application program interface (API) editing block function, insert a first API editing block at a selected location of the prompt, wherein the first API editing block may be filled with identification information of a predefined API.

In some embodiments, the editing interface includes an editing interface for a target function, the target function executed based on a target machine learning model, and the apparatus 900 also includes: a first presentation module, configured to present at least one fillable API in response to detecting a trigger on a first API editing block, wherein at least one API is associated with the target function; and an identification information filling module, configured to fill the identification information of the first API into the first API editing block in response to detecting a selection of a first API from the at least one API.

In some embodiments, the editing interface includes an editing interface for a target function, the target function executed based on a target machine learning model, and wherein the prompt includes a second API editing block, the second API editing block is filled with identification information of the second API, and the apparatus 900 also includes: a first style presentation module, configured to present the identification information of the second API as a visual style corresponding to a disabled state in response to the second API not being associated with the target function; a second presentation module, configured to present a fillable second API in response to detecting a trigger on the second API editing block; and a second style presentation module, configured to present the identification information of the second API as a visual style corresponding to an enabled state in response to detecting a selection of the second API.

In some embodiments, the apparatus 900 also includes: a first triggering detection module, configured to determine that a trigger on an editing block function is detected in response to detecting a selection of a predetermined control; or a second triggering detection module, configured to determine that a trigger on an editing block function is detected in response to detecting an input of a predetermined symbol in the editing interface.

In some embodiments, the editing interface includes an editing interface for a target function, the target function executed based on a target machine learning model, and the prompt determination module 930 is further configured to: confirm the content filled in the editing block as a part of the prompt in response to confirmation on creation of the target function.

In some embodiments, the editing interface includes an editing interface for creating a prompt for the prompt library, and the apparatus 900 further includes: a prompt adding module configured to add the edited prompt to the prompt library in response to confirmation on the editing of the prompt.

In some embodiments, the apparatus 900 also includes: an annotation content presentation module, configured to present the annotation content in a first visual style in response to determining that partial content input in the editing interface is marked as annotation content, wherein the annotation content will not be input into the machine learning model; and a code presentation module, configured to present, in a second visual style, at least partial predetermined symbols of code in a computer language in response to determining that partial content input in the editing interface is the code.

The modules included in the apparatus 900 may be implemented in various ways, including software, hardware, firmware, or any combination thereof. In some embodiments, one or more modules may be implemented using software and/or firmware, such as machine executable instructions stored on a storage medium. In addition to or as an alternative to machine executable instructions, some or all of the modules in the apparatus 900 may be implemented at least in part by one or more hardware logic components. As an example and not limitation, exemplary types of hardware logic components that may be used include field programmable gate arrays (FPGAs), application specific integrated circuits (ASICs), application specific standard products (ASSPs), systems on chips (SOCs), complex programmable logic devices (CPLDs), and the like.

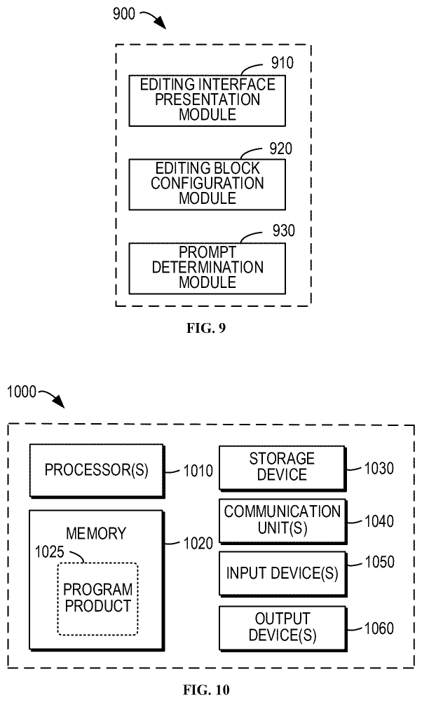

FIG. 10 shows a block diagram of an electronic device 1000 in which one or more embodiments of the present disclosure may be implemented. It should be understood that the electronic device 1000 shown in FIG. 10 is merely exemplary and should not constitute any limitation on the functionality and scope of the embodiments described herein. The electronic device 1000 shown in FIG. 10 may include or be implemented as the assistant creation platform 110 of FIG. 1, or the apparatus 900 of FIG. 9.

As shown in FIG. 10, the electronic device 1000 is in the form of a general electronic device. The components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and is capable of performing various processes according to a program stored in the memory 1020. In a multi-processor system, multiple processing units execute computer executable instructions in parallel to improve the parallel processing capability of the electronic device 1000.

The electronic device 1000 typically includes a plurality of computer storage media. Such media may be any accessible media accessible to the electronic device 1000, including but not limited to volatile and non-volatile media, removable and non-removable media. The memory 1020 may be a volatile memory (e.g., registers, caches, random access memory (RAM)), a non-volatile memory (e.g., a read-only memory (ROM), an electrically erasable programmable read-only memory (EEPROM), flash memory), or some combination thereof. The storage device 1030 may be a removable or non-removable medium, and may include a machine-readable medium, such as a flash drive, a disk, or any other medium, which may be capable of being used to store information and/or data and may be accessed within the electronic device 1000.

The electronic device 1000 may further include additional removable/non-removable, volatile/non-volatile storage media. Although not shown in FIG. 10, a disk drive for reading or writing from a removable, non-volatile disk (e.g., a “floppy disk”) and an optical drive for reading or writing from a removable, non-volatile optical disk may be provided. In these cases, each drive may be connected to a bus (not shown) by one or more data media interfaces. The memory 1020 may include a computer program product 1025 having one or more program modules that are configured to perform various methods or actions of various embodiments of the present disclosure.

The communication unit 1040 implements communication with other electronic devices through a communication medium. Additionally, the functions of the components of the electronic device 1000 may be implemented in a single computing cluster or multiple computing machines that may communicate through a communication connection. Therefore, the electronic device 1000 may operate in a networked environment using a logical connection with one or more other servers, a network personal computer (PC), or another network node.

The input device 1050 may be one or more input devices, such as a mouse, a keyboard, a tracking ball, etc. The output device 1060 may be one or more output devices, such as a display, a speaker, a printer, etc. The electronic device 1000 may also communicate with one or more external devices (not shown) through the communication unit 1040 as needed, such as a storage device, a display device, etc., communicate with one or more devices that allow a user to interact with the electronic device 1000, or communicate with any device (e.g., a network card, a modem, etc.) that allows the electronic device 1000 to communicate with one or more other electronic devices. Such communication may be performed via an input/output (I/O) interface (not shown).

According to an exemplary implementation of the present disclosure, a computer-readable storage medium is provided, on which computer-executable instructions are stored, wherein the computer-executable instructions are executed by a processor to implement the method described above. According to an exemplary implementation of the present disclosure, a computer program product is also provided, which is tangibly stored on a non-transitory computer-readable medium and includes computer-executable instructions, and the computer-executable instructions are executed by a processor to implement the method described above.

The present disclosure is described herein with reference to the flowcharts and/or block diagrams of the methods, apparatuses, devices, and computer program products implemented according to the present disclosure. It should be understood that each box in the flowchart and/or block diagram and the combination of each box in the flowchart and/or block diagram may be implemented by computer-readable program instructions.

These computer-readable program instructions may be provided to a processing unit of a general-purpose computer, a special-purpose computer, or other programmable data processing apparatuses, thereby producing a machine, so that when these instructions are executed by the processing unit of the computer or other programmable data processing apparatuses, a device that implements the functions/actions specified in one or more boxes in the flowchart and/or block diagram is generated. These computer-readable program instructions may also be stored in a computer-readable storage medium, and these instructions cause the computer, programmable data processing apparatus, and/or other equipment to work in a specific manner, so that the computer-readable medium storing the instructions includes a manufactured product, which includes instructions for implementing various aspects of the functions/actions specified in one or more boxes in the flowchart and/or block diagram.

Computer-readable program instructions may be loaded onto a computer, other programmable data processing apparatus, or other device so that a series of operational steps are performed on the computer, other programmable data processing apparatus, or other device to produce a computer-implemented process, so that the instructions executed on the computer, other programmable data processing apparatus, or other device implement the functions/actions specified in one or more boxes in the flowchart and/or block diagram.

The flow chart and block diagram in the accompanying drawings show the possible architecture, function and operation of the system, method and computer program product according to multiple implementations of the present disclosure. In this regard, each square box in the flow chart or block diagram may represent a part of a module, program segment or instruction, and a part of a module, program segment or instruction includes one or more executable instructions for realizing the logical function of the specification. In some implementations as an update, the function marked in the square box may also occur in a sequence different from that marked in the accompanying drawings. For example, two continuous square boxes may actually be executed substantially in parallel, and they may sometimes be executed in the opposite order, depending on the function involved. It should also be noted that each square box in the block diagram and/or flow chart, and the combination of the square boxes in the block diagram and/or flow chart may be realized by a special hardware-based system that performs the function or action of the specification, or may be realized by a combination of special hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each embodiment, or enable others of ordinary skill in the art to understand implementations of the present disclosure.

What is claimed is:

1. A method for prompt editing, comprising:
presenting an editing interface for editing a prompt, wherein the edited prompt is input into a machine learning model for the machine learning model to determine a model output;
configuring an editing block at a selected location of the editing interface in response to triggering an editing block function, wherein the editing block is fillable with content and content filled in the editing block is editable; and
determining the content filled in the editing block as a part of the prompt in response to confirmation on the editing of the prompt.

2. The method of claim 1, wherein a visual style of the editing block or content in the editing block is different from a visual style of content of a non-editing block in the prompt.

3. The method of claim 1, wherein configuring an editing block at a selected location of the prompt comprises:
configuring, in response to detecting a trigger on a text editing block function with at least partial text of the prompt being selected, a first text editing block based on the at least partial text at a location of the at least partial text, wherein the first text editing block is filled with the at least partial text.

4. The method of claim 1, wherein configuring an editing block at a selected location of the prompt comprises:
inserting, in response to detecting a trigger on a text editing block function without at least partial text of the prompt being selected, a second text editing block at an input cursor of the editing interface, wherein a filling guidance text is displayed in association with the second text editing block.

5. The method of claim 3, further comprising: for a given text editing block of the first text editing block,
presenting a text input interface for the given text editing block, the text input interface comprising at least one of a first input area or a second input area;
replacing a filled text in the given text editing block with a specified text in response to receiving the specified text in the first input area; and
receiving a filling guidance text for the given text editing block in the second input area, the filling guidance text being displayed in response to no text being filled in the given text editing block.

6. The method of claim 1, wherein configuring an editing block at a selected location of the prompt comprises:
inserting a first application program interface (API) editing block at a selected location of the prompt in response to detecting a trigger on an API editing block function, wherein the first API editing block is fillable with identification information of a predefined API.

7. The method of claim 6, wherein the editing interface comprises an editing interface for a target function executed based on a target machine learning model, and the method further comprises:
presenting at least one fillable API in response to detecting a trigger on the first API editing block, wherein the at least one API is associated with the target function; and
filling identification information of a first API into the first API editing block in response to detecting a selection of the first API from the at least one API.

8. The method of claim 1, wherein the editing interface comprises an editing interface for a target function executed based on a target machine learning model, and wherein the prompt comprises a second API editing block filled with identification information of a second API, the method further comprising:
presenting, in response to the second API not being associated with the target function, the identification information of the second API in a visual style corresponding to a disabled state;
presenting, in response to detecting a trigger on the second API editing block, the second API that is fillable; and
presenting, in response to detecting a selection of the second API, the identification information of the second API in a visual style corresponding to an enabled state.

9. The method of claim 1, further comprising:
determining, in response to detecting a selection of a predetermined control, that a trigger on the editing block function is detected; or
determining, in response to detecting an input of a predetermined symbol in the editing interface, that a trigger on the editing block function is detected.

10. The method of claim 1, wherein the editing interface comprises an editing interface for a target function executed based on a target machine learning model, and wherein confirming the content filled in the editing block as a part of the prompt comprises:
confirming the content filled in the editing block as a part of the prompt in response to confirmation on creation of the target function.

11. The method of claim 1, wherein the editing interface comprises an editing interface for creating a prompt for a prompt library, the method further comprising:
adding an edited prompt into the prompt library in response to confirmation on the editing of the prompt.

12. The method of claim 1, further comprising:
presenting annotation content in a first visual style in response to determining that partial content input in the editing interface is marked as the annotation content, wherein the annotation content is not intended to be input into the machine learning model; and
presenting, in a second visual style, at least partial predetermined symbols of code in a computer language in response to determining that the partial content input in the editing interface is the code.

13. An electronic device comprising:
at least one processor; and
at least one memory, coupled to the at least one processor and storing instructions to be executed by the at least one processor, the instructions, when executed by the at least one processor, causing the electronic device to perform operations comprising:
presenting an editing interface for editing a prompt, wherein the edited prompt is input into a machine learning model for the machine learning model to determine a model output;
configuring an editing block at a selected location of the editing interface in response to triggering an editing block function, wherein the editing block is fillable with content and content filled in the editing block is editable; and
determining the content filled in the editing block as a part of the prompt in response to confirmation on the editing of the prompt.

14. The electronic device of claim 13, wherein a visual style of the editing block or content in the editing block is different from a visual style of content of a non-editing block in the prompt.

15. The electronic device of claim 13, wherein configuring an editing block at a selected location of the prompt comprises:
configuring, in response to detecting a trigger on a text editing block function with at least partial text of the prompt being selected, a first text editing block based on the at least partial text at a location of the at least partial text, wherein the first text editing block is filled with the at least partial text.

16. The electronic device of claim 13, wherein configuring an editing block at a selected location of the prompt comprises:
inserting, in response to detecting a trigger on a text editing block function without at least partial text of the prompt being selected, a second text editing block at an input cursor of the editing interface, wherein a filling guidance text is displayed in association with the second text editing block.

17. The electronic device of claim 15, wherein the operations further comprise: for a given text editing block of the first text editing block,
presenting a text input interface for the given text editing block, the text input interface comprising at least one of a first input area or a second input area;
replacing a filled text in the given text editing block with a specified text in response to receiving the specified text in the first input area; and
receiving a filling guidance text for the given text editing block in the second input area, the filling guidance text being displayed in response to no text being filled in the given text editing block.

18. The electronic device of claim 13, wherein configuring an editing block at a selected location of the prompt comprises:
inserting a first application program interface (API) editing block at a selected location of the prompt in response to detecting a trigger on an API editing block function, wherein the first API editing block is fillable with identification information of a predefined API.

19. The electronic device of claim 18, wherein the editing interface comprises an editing interface for a target function executed based on a target machine learning model, and the operations further comprise:
presenting at least one fillable API in response to detecting a trigger on the first API editing block, wherein the at least one API is associated with the target function; and
filling identification information of a first API into the first API editing block in response to detecting a selection of the first API from the at least one API.

20. A non-transitory computer-readable storage medium, with a computer program stored thereon, the computer program being executable by a processor to implement operations comprising:
presenting an editing interface for editing a prompt, wherein the edited prompt is input into a machine learning model for the machine learning model to determine a model output;
configuring an editing block at a selected location of the editing interface in response to triggering an editing block function, wherein the editing block is fillable with content and content filled in the editing block is editable; and
determining the content filled in the editing block as a part of the prompt in response to confirmation on the editing of the prompt.
